(19) United States
(12) Patent Application Publication
(10) Pub. No.: US 2015/0231742 A1
(43) Pub. Date: Aug. 20, 2015

(54) BRAZING ALLOYS

(71) Applicant: MORGAN ADVANCE CERAMICS INC., Hayward, CA (US)

(72) Inventor: Abdelouahab Ziani, Santa Clara, CA (US)

(21) Appl. No.: 14/428,544

(22) PCT Filed: Sep. 20, 2013
(86) PCT No.: PCT/EP2013/069582

§ 371 Date: Mar. 16, 2015

Related U.S. Application Data
(60) Provisional application No. 61/703,420, filed on Sep. 20, 2012.

(51) Int. Cl. B23K 35/32; B23K 1/19; B23K 35/02

(52) U.S. Cl. CPC B23K 35/325; B23K 35/025; B23K 35/32; B23K 1/19

(57) ABSTRACT

An alloy is provided having the composition TiₓZr_{y}Co_{z}R_{1-x-y-z} wherein R represents any element other than Ti, Zr, or Co 0.182≦x≦0.718 0.154≦y≦0.681 0.08≦z≦0.3 and 0.95≦x+y+z≦1. the alloy may be used to braze titanium and titanium alloys.

This invention relates to brazing alloys and to methods of brazing.

Brazing is a joining process in which a filler metal is heated above its melting point and distributed between two or more close-fitting parts by capillary action without melting the parts. For best results the chemical composition of the filler metal is chosen to reduce any adverse reaction with the parts to be joined.

Brazing is performed in several different ways, for example:—
Torch brazing—where the filler metal, often in the form of a rod or wire, is applied to the joint and melted with a torch
Braze welding—which does not rely on capillary action but simply on flow of the filler metal.
Furnace brazing—where the filler metal is placed in or close to the joint and an assembly of parts and filler metal is placed into a furnace where the filler metal melts and flows to make the joint between the parts.

For different applications:—
different brazing temperatures apply according to the nature of the parts being joined [they must not melt or otherwise deteriorate at the brazing temperature];
different chemical constituents are required to match the chemical composition of the parts [there must be no adverse reaction with the parts and chemical couples that might lead to corrosion need to be avoided or minimized]
different physical characteristics are required [e.g. to match the coefficients of thermal expansion of the parts or, where the parts are of different material, to provide a gradation of properties across the joint].

Brazing of titanium alloy parts presents a particular problem, in that although titanium has a high melting point it undergoes a transformation from a close-packed hexagonal a phase to a body-centred cubic β phase above a transformation temperature specific to that alloy.

It is important therefore to undertake brazing of titanium alloys below the transformation temperature of the alloy.

Mechanical properties of heat treatable titanium alloys may be altered greatly by process heat cycling. Selection of brazing cycles and filler alloys that are compatible with the heat treatments required for those alloys usually presents significant difficulty. Typically, it is recommended to conduct the brazing operation at a temperature 38-66° centigrade below the α-β transition temperature of the alloy being brazed

The majority of commercial titanium alloys used in aerospace and medical devices have a transition temperature in the range 880-1050° C.

Conventional filler materials used for brazing assemblies of titanium and its alloys are mainly silver alloys with alloying additions of lithium, copper, aluminum or tin. There are also some commercial filler alloys such as silver-palladium, silver-aluminum, titanium-nickel, titanium-nickel-copper and titanium-zirconium-beryllium.

Besides being not cost effective materials, silver-palladium and silver-aluminum based filler alloys do not meet minimum joint strength specifications for key aerospace and defense applications.

Ti-Ni, Ti-Cu-Ni, Ti-Zr-Be and Ti-Zr-Ni-Be alloys either produce brittle joints that do not meet strength specifications (beryllium containing alloys) or exhibit liquidus temperatures higher than 900° C. and are therefore unusable for brazing below the α-β transition temperature (Ti-Ni and Ti-Cu-Ni alloys).

For those applications where brazing above the α-β transition temperature has been tolerated, Ti-Cu-Ni filler composition produced the best joint strength. The improved strength in those joints was ascribed to the formation of a Widmanstätten-type microstructure at the joint diffusion layer. The development of the Widmanstatten microstructure has been stated to be induced by the presence of copper.

Some conventional filler alloy constituent elements [e.g. Ni, Cu and Be [added for the purposes of improving: joint strength, molten filler flow and liquidus temperature depression]] are undesirable metals in biocompatible medical implants, thus restricting the use of those filler alloys for braze joining of medical devices.

Large titanium honeycomb sandwich structures having satisfactory strength have been successfully brazed using aluminum 3003 (Al-1.3% Mn) for applications below 316° C. In joining applications requiring high degree of durability, fatigue strength, oxidation and corrosion resistance at higher temperatures, 871 to 927° C. (1600 to 1700 F) range, alloys such as 70Ti-15Cu-15Ni, 60Ti-20Cu-20Ni, 48Ti-48Zr-4Be, 43Ti-43Zr-12Ni-2Be and Ag-9Pd-9Ga have been used.

There are existing low melting point brazing alloys based on the Zr-Ti-Cu-Ni alloy family [see for example U.S.2011/0211987]. However U.S.2011/0211987 noted that Cu can be detrimental to durability of a titanium brazed assembly. It is believed that Cu weakens oxidation resistance of a braze at high temperature. Additionally, Ni has been suggested as potentially causing allergenic reactions.

The inventor has developed a different class of alloys that comprises biocompatible metal elements (Ti, Zr, Co) that can be used for brazing titanium and/or titanium alloys to one or more of:—
titanium
titanium alloy
other metals and alloys
oxide or non-oxide ceramics
glasses
   at brazing temperatures below the α-β transition temperature of the titanium or titanium alloy being brazed. The invention is not restricted to these applications and the brazing alloys can be used for other metals or indeed above the α-β transition temperature for titanium alloys having a particularly low α-β transition temperature.

Accordingly the present invention provides an alloy having the composition TiₓZr_{y}Co_{z}R_{1-x-y-z} wherein
R represents any element other than Ti, Zr, or Co
0.182≦x≦0.718
0.154≦y≦0.681
0.08≦z≦0.3
   and
0.95≦x+y+z≦1.

In further optional features of the invention:—
the alloy may have a liquidus below 880° C.
x may be greater than 0.2 or greater than 0.25 or greater than 0.3 or greater than 0.35 or greater than 0.4
x may be less than 0.65 or less than 0.6 or less than 0.55 or less than 0.5
y may be greater than 0.2 or greater than 0.25 or greater than 0.3
y may be less than 0.65 or less than 0.6 or less than 0.55 or less than 0.5 or less than 0.45 or less than 0.4
z may be greater than 0.1 or greater than 0.15
z may be less than 0.25 or less than 0.2
R may comprise or consist of incidental impurities
x+y+z may be greater than 0.96 or greater than 0.97 or greater than 0.98 or greater than 0.99 or greater than 0.995
the alloy may have an alloy composition Ti_{0.492}Zr_{0.314}Co_{0.194}.

Further, the invention provides alloy precursors that on melting form an alloy as claimed herein. The precursors may comprise two or more metal layers of different composition that when melted form an alloy as claimed. The precursors may comprise at least one compound of at least one of the elements of the alloy and the at least one compound may comprise at least one hydride.

The invention further provides an article comprising at least one component formed from titanium or titanium alloy brazed to at least one component formed from a material selected from the group metals, alloys, ceramics, or glasses, and comprising at least one brazed joint formed from an alloy or alloy precursor as claimed herein.

The invention yet further provides a method of joining at least one component formed from titanium or titanium alloy to at least one component formed from a material selected from the group metals, alloys, ceramics, or glasses, comprising the use of an alloy or alloy precursor as claimed herein. The method may comprise the step of heat treating the article subsequent to forming the at least one brazed joint.

The invention is illustrated by way of the following non-limitative examples in the following description with reference to the drawings in which:—

FIG. 1 is a differential scanning calorimetry (DSC) trace for an alloy in accordance with the invention;

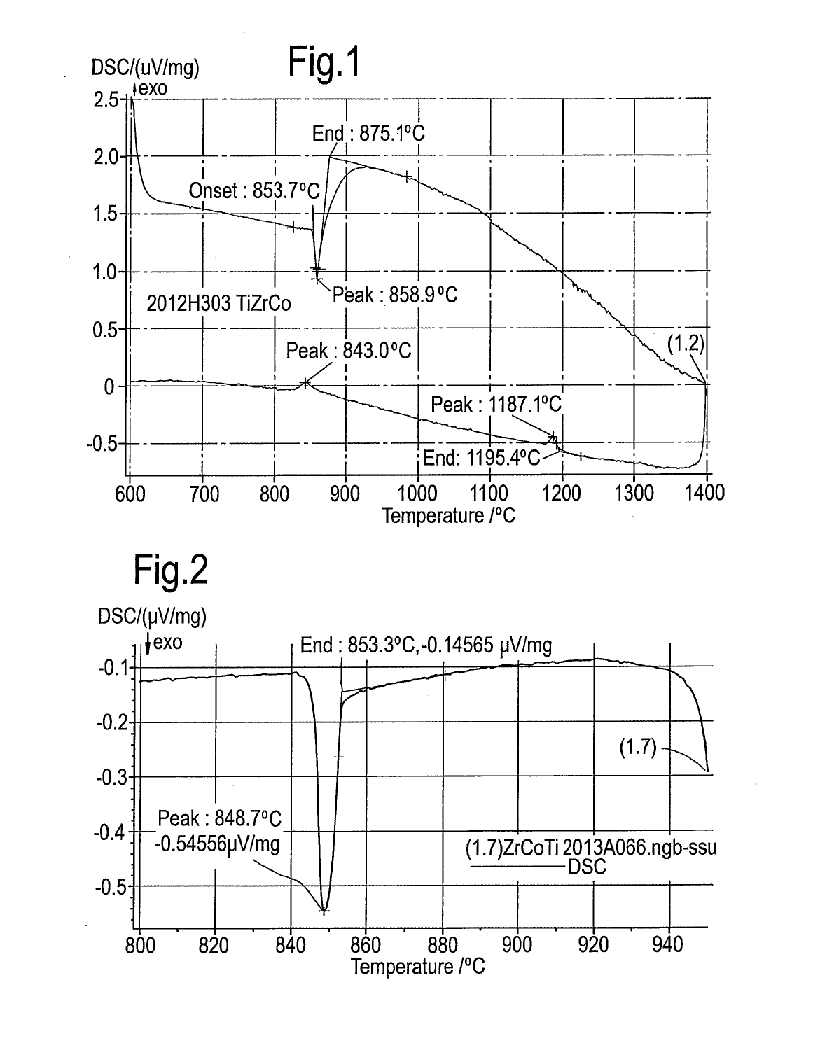

FIG. 2 is a differential scanning calorimetry (DSC) trace for an alloy foil in accordance with the invention;

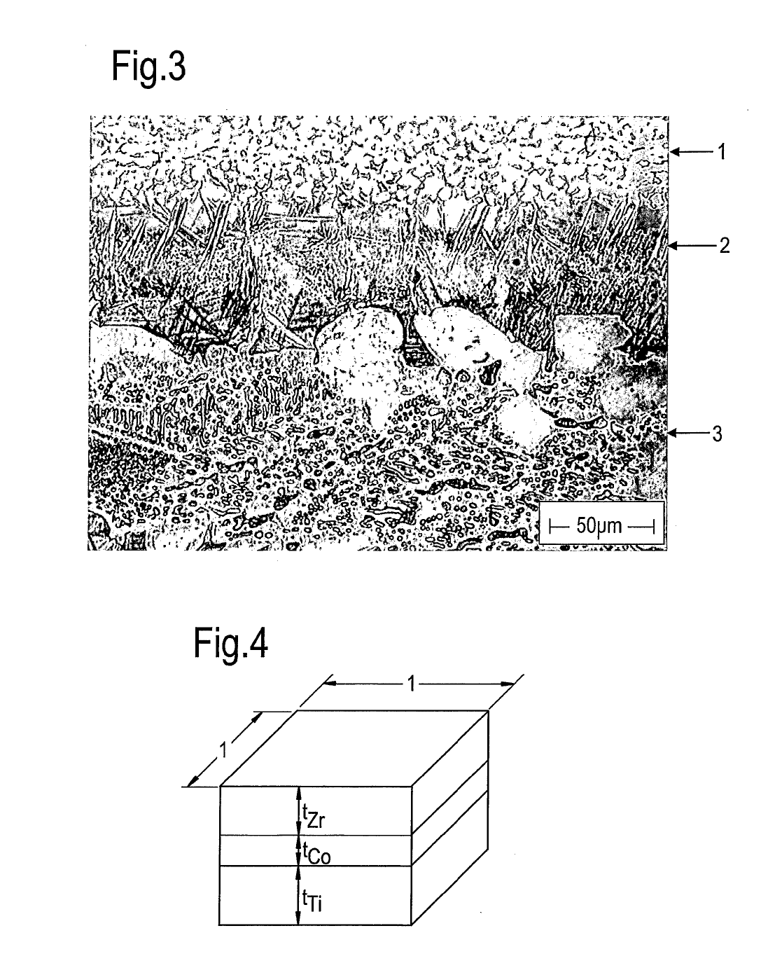

FIG. 3 is a micrograph of part of a joint formed using an alloy according to the present invention;

FIG. 4 is a schematic diagram of relationships in a stacked structure;

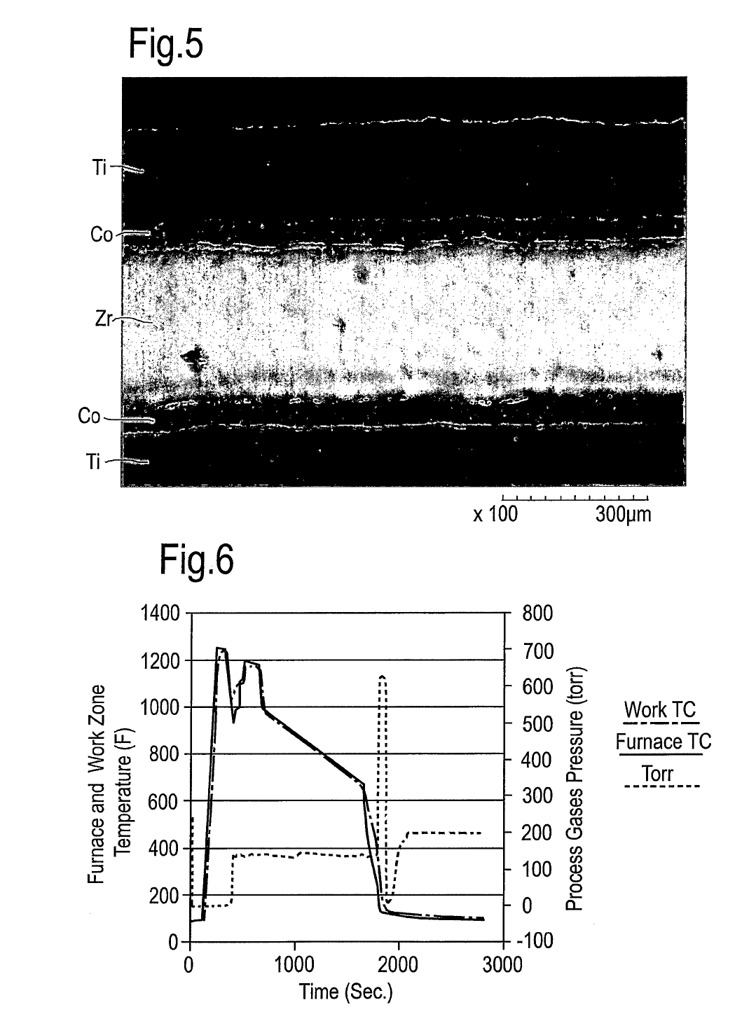

FIG. 5 is a micrograph of a layered foil in accordance with the invention;

FIG. 6 is a graph indicating processing conditions for forming a powder brazing alloy in accordance with the invention.

### EXAMPLE 1

An arc melted alloy sample was prepared comprising in weight % 45.02% Zirconium, 36.98% Titanium and 18.00% Cobalt [equivalent to an alloy composition Ti_{0.492}Zr_{0.314}Co_{0.194}]. This was tested in a differential scanning calorimeter and shown to melt around 860° C. [peak at 858.9° C.].

This low melting point is in marked contrast to the lowest melting point binary Ti-Zr alloy [reported by the ASM Alloy Phase Diagrams Center as at around the composition Ti_{0.62}Zr_{0.38} (roughly Zr˜54wt %, Ti˜46wt %) which has a liquidus at about 1540° C.].

The small peak in the DSC trace at about 1187° C. represents nucleation of a solid phase upon cooling from the molten state. Therefore, when casting these alloys it is preferred to maintain a sufficiently high solidification rate to prevent the nucleation of high melting temperature phases. Cooling the molten alloy on the water cooled copper plate of an arc melter provides sufficiently fast cooling for this purpose, although the invention is not limited to this manner of manufacture.

### EXAMPLE 2

A thin lamella (a sawn-off slice, 0.5 mm thick) of the arc melted sample of Example 1 was placed between two plates of Ti-6Al-4V base metal to form a test joint. The joint assembly was furnace brazed at 880° C. for 10 minutes under 0.266×10 ⁻⁶ kPa [˜2×10⁻⁶ torr] vacuum. A sample of the brazed joint was polished and examined by optical microscopy to reveal the features of the joint. It can be seen that a diffusion layer 2 with a Widmanstäten-type microstructure is formed between the Ti-6Al-4V base metal 1 and filler metal 3. Formation of a Widmanstätten-type microstructure at the joint diffusion layer has been suggested as providing improved strength in brazes using Ti-Cu-Ni filler metals at above the α-β transition temperature.

### EXAMPLE 3

The as-cast alloy ingot of Example 1 is too hard for further break down by cold rolling. Hot working of the material is undesirable or not possible due to the high reactivity of zirconium content to ambient atmosphere. However the alloying elements of the material may be combined to form a layered structure that can be hot rolled at a temperature that is just high enough to cause bonding of individual layers and prevent full inter-diffusion among said layers that would cause an increase in hardness of the structure.

For a given alloy weight composition, relative thicknesses of the amounts required can be determined as follows:

If an elemental cube of the layered structure having a unit face area as indicated in FIG. 3 is considered, the relationships between the thicknesses of the layers can be determined by the following formulas:

$${t}_{Co} = \frac{{ρ}_{Ti}}{{ρ}_{Co}} \cdot \frac{{f}_{w}^{Co}}{{f}_{w}^{Ti}} \cdot {t}_{Ti}$$

$${t}_{Zr} = \frac{{ρ}_{Ti}}{{ρ}_{Zr}} \cdot \frac{{f}_{w}^{Zr}}{{f}_{w}^{Ti}} \cdot {t}_{Ti}$$

tᵢ: Layer thickness of constituent i
ρᵢ: Theoretical density of constituent i
ƒ_{w}ⁱ: Weight fraction of constituent i

The invention is not limited to three layers of pure metal, and this formula merely gives the relative overall thicknesses required. More than three layers may be used as exemplified below. Two layers may be used if, for example, one at least of the layers comprises an alloy of two or more alloy constituents.

A 152 mm [6.0″] wide×508 mm [20.0″] long plate assembly was built having a five layer Ti-Co-Zr-Co-Ti construction. The invention is not limited to any particular distribution of layers, but in this case: Zr formed the innermost layer, since Zr is more sensitive to oxidation at high temperatures experienced during rolling: two Co layers were provided, rather than one, to ensure a more even distribution of Co through the assembly than if a single layer were used. The layers comprised a 5.23 mm [0.2058″] thick Zr plate, two 0.762 mm [0.0300″] thick Co plates and two 6.18 mm [0.2433″] thick titanium plates to meet the nominal composition of Zr45-Ti37-Co18 wt. %. Hot rolling process at 788° C. [1450° F.] was applied, including a sequence of 4 reductions with reheating to 788° C. [1450° F.] after each pass at 40% mill breakdown. Cold rolling was accomplished on a two high rolling mill through 5 thickness reductions of 10% including a full 5 hours annealing at 760° C. [1400° F.] in nitrogen atmosphere. Final thickness reduction to 0.508 mm [0.02″] foil thickness was achieved by cluster mill rolling. The layered foil structure obtained through this process is shown in FIG. 5. Chemical analysis of a foil sample indicated an actual composition of Zr45.07-Ti37.00-Co17.93 wt. %.

The differential scanning calorimetry (DSC) depicting the melting behavior of the layered foil is shown in FIG. 2. The DSC trace indicate a liquidus temperature of 849° C. that is similar to the range detected for the laboratory sample made by arc melting.

### EXAMPLE 4

A charge of 6.8 kg [15 lbs] of alloy raw materials consisting of 3.07 kg [6.75 lbs] of 99.9% pure thin zirconium strips, 2.52 kg [5.55 lbs] of 99.95% pure titanium plate shearing drops and 1.22 kg [2.70 lbs] of 99.95% pure pieces of electrolytic cobalt was melted under vacuum in a zirconia crucible and cast into a 0.75″ thick ingot.

The cast material was subjected to hydride processing under pure hydrogen atmosphere at high temperature to form brittle compounds comprising titanium and zirconium hydrides. The hydride process chart is shown in FIG. 6. A work thermocouple was inserted in the ingot, and a furnace thermocouple was situated in the furnace hot zone. When both work and furnace thermocouples indicated a temperature of 649° C. [1200° F.], hydrogen was introduced to a pressure of 53.3 kPa [400 torr]. After a slight decrease in temperature below 538° C. [1000° F.] due to cold hydrogen chilling effect temperature started rising as a result of the exothermic reaction associated with hydride formation. At this point furnace power was turned off to allow the work zone to cool down to 204° C. [400° F.]. Further cooling and hydrogen purge was carried out with inert gas (argon) injection as seen by the gas pressure peak on the graph.

The hydrided material was easily crushed and milled into a −80 mesh powder that was subsequently sieved into a fraction of −100/+325 mesh powder for paste making.

Typically, brazing pastes are combinations of filler alloy powder, acrylic or wood flower based binders that pyrolize at or below 800° C. without leaving residues or ashes, suitably mixed with wetting agents such alcohol or other organic solvents. Any known paste components may be used with the powders of the present invention, as may any other suitable binders, solvents, and viscosity modifying materials.

Further Features

Further methods that may be used in the manufacturing of the materials include rapid solidification techniques, e.g. melt spinning either under vacuum or inert atmosphere; or inert gas atomization. It should be noted that nitrogen is not inert in this sense, as it can form nitrides with the molten metal.

The alloys of the invention comprise Zr, Ti and Co each of which are biocompatible metals. Other constituents may be included in the alloys and these are preferably biocompatible constituents. For example chromium and molybdenum may be added to improve corrosion resistance and strength. However minor amounts of non-biocompatible constituents may be tolerated for some applications.

At time of filing the provisional application, the applicant had not found a published complete phase diagram data for the ternary Ti-Zr-Co alloy system although a pseudo-binary diagram for the composition Co_{0.667}Ti_{0.333-x}Zrₓ with 0≦x≦0.333 was available on the ASM International phase diagram data base [Diagram no.925431]. This shows melting points above 1200° C.

The individual Co-Ti and Co-Zr phase diagrams show eutectic compositions occurring at 1020° C. and 1200° C. in the Ti-rich and Zr-rich regions respectively.

In the Ti-Zr phase diagram there is minimum melting point at 1540° C. and a compositional atomic ratio Ti:Zr of about 61:39. The composition exemplified above corresponds to addition of cobalt to this compositional atomic ratio, as showing approximately a (Ti₆₁Zr₃₉)₈₀Co₂₀ atomic composition that is equivalent to Ti36.74-Zr44.74-Co18.53 wt. %.

As the temperature-composition slope of the melting point for the Ti-Zr phase diagram is quite shallow, a broad range of Ti-Zr ratios around the minimum are expected to provide low melting point composition suitable for the brazing alloys of the present invention. Similarly a range of Co contents are expected to provide low melting point compositions suitable for the brazing alloys of the present invention.

Indeed, this expectation has been verified by a subsequently published article V. F. Khorunov, , V. V. Voronov & S. V. Maksimova, Welding International (2013): Investigation of brazing alloys of the Ti—ZrCo System, DOI: 10.1080/09507116.2013.796666 which in FIG. 1 shows a calculated phase diagram showing a broad band of low melting point alloys.

The exemplified and related alloys within the general definition above are expected to be useful in brazing assemblies as indicated above. The alloys may be provided in any known form [including, but not limited to foil, strip, wire, paste, powder, preforms] and may particularly be useful in aerospace applications [e.g. Ti brazing on Nacelle components (reverse thrusters, sound panels, exhaust nozzles)] and in medical implantable devices to meet biocompatibility requirements, however the invention is not limited to these applications.

1. An article comprising at least one component formed from titanium or titanium alloy brazed to at least one component formed from a material selected from the group metals, alloys, ceramics, or glasses, and comprising at least one brazed joint wherein the brazed joint is formed from an alloy having the composition TiₓZr_{y}Co_{z}R_{1-x-y-z}, or an alloy precursor that on melting forms such alloy
wherein
R represents any element other than Ti, Zr, or Co
0.182≦x≦0.718
0.154≦y≦0.681
0.08≦z≦0.3
and
0.95≦x+y+z≦1.

2. An article as claimed in claim 1, in which R comprises or consists of incidental impurities.

3. An article as claimed in claim 1, in which R comprises or consists of one or more biocompatible elements.

4. An article as claimed in claim 1, in which x is greater than 0.2 or greater than 0.25 or greater than 0.3 or greater than 0.35 or greater than 0.4.

5. An article as claimed in claim 1, in which x is less than 0.65 or less than 0.6 or less than 0.55 or less than 0.5.

6. An article as claimed in claim 1, in which y is greater than 0.2 or greater than 0.25 or greater than 0.3.

7. An article as claimed in claim 1, in which y is less than 0.65 or less than 0.6 or less than 0.55 or less than 0.5 or less than 0.45 or less than 0.4.

8. An article as claimed in claim 1, in which z is greater than 0.1 or greater than 0.15.

9. An article as claimed in claim 1, in which z is less than 0.25 or less than 0.2.

10. An article as claimed in claim 1, in which x+y+z is greater than 0.96 or greater than 0.97 or greater than 0.98 or greater than 0.99 or greater than 0.995.

11. An article as claimed in claim 1, in which the alloy has a liquidus below 880° C.

12. An alloy precursor that when melted in a brazing process with at least one component formed from titanium or titanium alloy and at least one component formed from a material selected from the group metals, alloys, ceramics, or glasses forms an article as claimed in claim 1, the precursor comprising two or more metal layers of different composition that when melted form an alloy as specified in claim 1.

13. An alloy precursor that when melted in a brazing process with at least one component formed from titanium or titanium alloy and at least one component formed from a material selected from the group metals, alloys, ceramics, or glasses forms an article as claimed in claim 1, the precursor comprising at least one compound of at least one of the elements of the alloy.

14. An alloy precursor as claimed in claim 13, in which the at least one compound comprises at least one hydride.

15. A brazing alloy paste comprising a powder of an alloy or alloy precursor that when melted in a brazing process with at least one component formed from titanium or titanium alloy and at least one component formed from a material selected from the group metals, alloys, ceramics, or glasses forms an article as claimed in claim 1.

16. A method of joining at least one component formed from titanium or titanium alloy to at least one component formed from a material selected from the group metals, alloys, ceramics, or glasses, comprising the use in brazing of an alloy having the composition TiₓZr_{y}CO_{z}R_{1-x-y-z}, or an alloy precursor that on melting forms such an alloy, wherein R, x,y, and z have the meaning specified in claim 1, to form an article as claimed in in claim 1.

17. A method as claimed in claim 16 further comprising the step of heat treating the article subsequent to forming the at least one brazed joint.

18. An alloy having the composition TiₓZr_{y}Co_{z}R_{1-x-y-z}, or an alloy precursor that on melting forms such alloy
wherein
R represents any element other than Ti, Zr, or Co
0.182≦x≦0.718
0.154≦y≦0.681
0.08≦z≦0.3
and
0.95≦x+y+z≦1
and having a compositional atomic ratio Ti:Zr of about 61:39.
